(19) United States
(12) Patent Application Publication
(10) Pub. No.: US 2015/0316962 A1
(43) Pub. Date: Nov. 5, 2015

(54) FRAME SYSTEM FOR FLEXIBLE PANEL

(71) Applicant: AVERLY IP LIMITED, London, Greater London (GB)

(72) Inventor: Adrian HOWES, London (GB)

(73) Assignee: AVERLY IP LIMITED, London, Greater London (GB)

(21) Appl. No.: 14/646,933

(22) PCT Filed: Nov. 12, 2013
(86) PCT No.: PCT/GB2013/052974

§ 371 Date: May 22, 2015

(30) Foreign Application Priority Data
Nov. 23, 2012 (GB) 1221099.3

(51) Int. Cl. G06F 1/16; G03B 21/58

(52) U.S. Cl. CPC G06F 1/1652; G03B 21/58

(57) ABSTRACT

A frame system for supporting flexible panels or displays, where the frame system includes at least one member formed from a memory material. The memory material is flexible in a first configuration and rigid in a second configuration.

This invention relates to a frame system for supporting flexible panels or displays.

With the increasing diversity of flexible panels and display systems there is a need for a mechanism that allows systems to have the advantage of both being flexible, to enable such panels or displays to be bent, twisted or rolled up, and yet to also have the necessary rigidity, when required, to make them sturdy and functionally useful for certain applications. Previous efforts have focused on rigid frame systems for supporting rigid screens such as liquid crystal displays or on flexible panels not requiring a rigid support across the whole frame. The focus of these prior art systems has typically been on minimising the amount of support required for a typical display or panel thereby enabling lighter and/or thinner display systems.

An object of the present invention is to provide a mechanism which may be used to support any type of flexible panel, screen or display, whether formed from a sheet of some flexible material, such as a plastic (e.g. PVC or polyester) or natural material (e.g. cotton or ticking), or a flexible electronic system such as an organic LED display and/or a touch interface (e.g. a keyboard or touchpad).

The mechanism may therefore be used, for example, on any type of flexible display system whether a simple passive display (e.g. for projecting images onto a blank screen or displaying printed material) or an active display (e.g. utilising an organic LED system comprising suitable flexible substrates). Equally, the mechanism may be used as a purely mechanical device where both flexibility and rigidity may be required in one particular dimension to support a two dimensional surface, for example, perpendicular to the surface.

According to the invention there is provided a flexible panel comprising at least one rigid support and at least one supporting member formed from a memory material, the memory material being flexible in a first configuration and rigid in a second configuration.

In a first, flexible configuration, the memory material may have a flat cross-section, whilst in the second, rigid configuration the memory material may have a bent, curved or circular cross-section. The memory material provides a collapsible, adaptable support to the flexible panel. The memory material may be arranged to bend, curve or expand independently of the flexible panel. It may also form part of the flexible panel.

The supporting member may be positioned at an angle to the at least one rigid support. The supporting member may be positioned at an angle substantially perpendicular to the at least one rigid support, or alternatively at an angle of between 30-60° to the at least one rigid support.

The flexible panel may comprise at least two adaptable supporting members formed from a memory material. The flexible panel may also comprise at least two rigid supports. At least one edge of one of the supporting members or the rigid supports may be attached at or near to the edge of the flexible panel. The rigid support may also form part of the flexible panel.

The memory material can change configuration from a second, rigid configuration to a first, flexible configuration. The flexible panel may include a mechanism arranged to exert a force upon the memory material in order to change the configuration of the memory material. Alternatively, or additionally, the flexible panel may comprise a mechanism for applying heat, or of applying an electrical pulse to the memory material in order to change the configuration of the memory material.

The supporting members formed from a memory material may include at least one cut-away portion.

The flexible panel may be arranged to pass over a roller or a guiding means, or a first end of the flexible panel or the supporting members may be fixed to a roller.

The flexible panel may be secured within a housing, and the housing may further comprise an opening through which the flexible panel can pass.

The housing may comprise at least one internal indentation or slot. A first end of the flexible panel may be arranged to move within the confines of the internal indentation or slot. The central portion of the panel may be also arranged to pass over a roller or guiding means. Alternatively, a first end of the panel may be mounted to a fixed point within the housing, where the central portion of the panel is arranged to pass over a roller or guiding means, and the roller or guiding means may be arranged to move within the confines of the internal indentation or slot.

Typical dimensions of the flexible panel will vary depending on the application. Typical flexible panels for domestic electronic display purposes have varied aspect ratios, affecting the horizontal and vertical measurements of the screen/panel size. Commonly, screen size is defined by the diagonal measurement, combined with a measure of the aspect ratio. The flexible panels of the present invention may have a diagonal screen size of between approximately 3 inches (8 cm) up to approximately 80 inches (approximately 2 m) for domestic applications. The flexible panel may also be used outside the domestic environment for applications such as for advertising display screens, concert screens, presentation screens, the screening of public broadcasts, etc., where the size of the flexible panel is greater than 80 inches (2 m) and preferably greater than 120 inches (approximately 3 m).

The adaptable supporting member may adopt both a flexible and rigid (or semi-rigid) configuration by changing its form between at least two configurations. The first configuration may have a flat or substantially flat cross-section. The second configuration may be an alternative arrangement providing greater rigidity to the supporting member than the first configuration by adopting a substantially three-dimensional structure. The second configuration may be circular or substantially circular, curved, U-shaped, a rolled-over circular, V-shaped, S-shaped, arced, bent, curled, spiralled or any configuration that lends support and rigidity to the member. The first configuration is more flexible across one dimension than the second configuration. The second configuration has more material supporting it parallel to that dimension than the first configuration, which provides greater rigidity.

Each adaptable supporting member may be made of any suitable material which resists plastic deformation and favours the second configuration while also being capable of adopting the first configuration when forced by some mechanical means. Alternatively, or additionally, the material may transition from the first to the second configuration, or vice versa, on the application of heat or an electrical pulse to the material. Examples of suitable memory materials include, for example, a shape memory alloy (e.g. titanium based alloys such as Flexon® or nitinol) or a suitable elastic or shape memory based polymer (e.g. polyurethane). The choice of material and the size of the members will depend on the size, weight, desired rigidity and purpose of the flexible panel. Each member may be fixed to the flexible panel by providing the member with a flat surface along one edge which may be glued or fixed to the panel by other means known to the skilled person. The member may also form part of the flexible panel. When the supporting member assumes the second configuration, the substantially curved, bent or circular cross-section of the supporting member is substantially perpendicular to the flexible panel. Whilst the flexible panel may unravel or slide in a first direction, the supporting member curls or expands in a second direction. The use of a flexible supporting member allows the flexible panel to be stored in a compact state. When the supporting member is activated into the second configuration, it provides support to the panel and ensures that the surface of the panel is substantially flat.

As an alternative to the use of two supporting members and the flexible panel may be supported by a single adaptable supporting member formed from a memory material. The single adaptable supporting member may be positioned diagonally on one surface of the flexible panel (not illustrated), with the panel held taut by at least one further rigid support (and optionally a second rigid support). In this arrangement, the supporting member may form an angle of approximately 30-60° to at least one rigid support positioned at the end of the flexible panel. When the adaptable supporting member is in a first, flexible configuration the panel remains flexible. When the adaptable supporting member is in a second, rigid configuration the panel is kept flat or substantially flat by the adaptable supporting member in combination with at least one rigid support. When the memory material adopts a second configuration, the curved, bent or expanded cross-section extends in a direction away from the surface of the flexible panel.

Preferred/optional features relating to one embodiment may apply equally to separate embodiments.

Examples of the present invention will now be described, by way of example only, with reference to the accompanying diagrammatic drawings, in which:

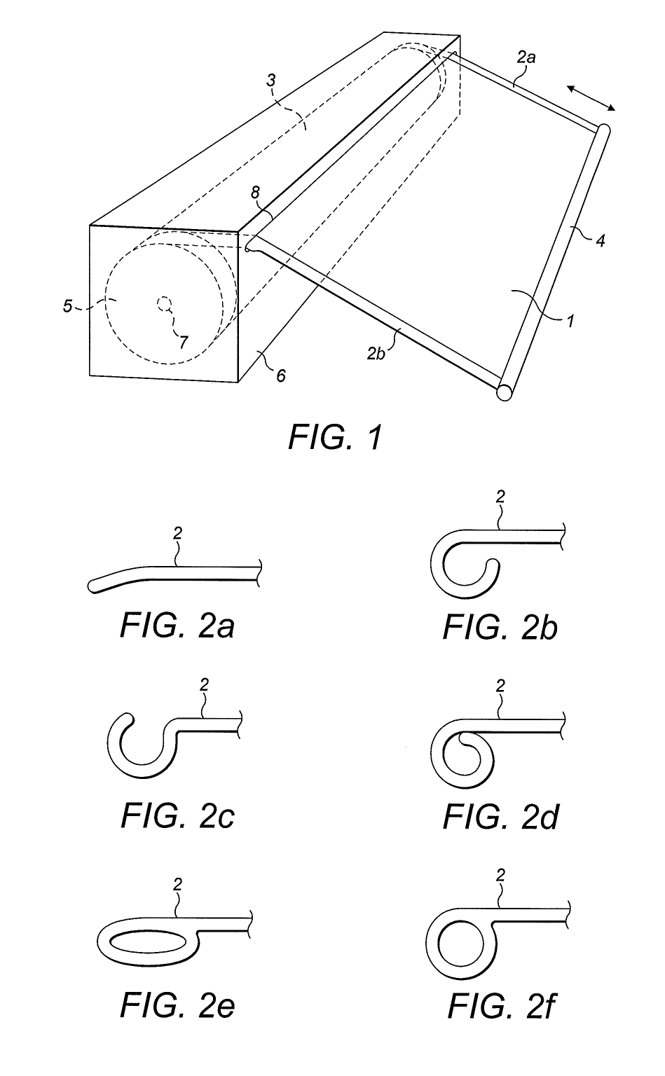

FIG. 1 shows schematically an isometric view of a flexible panel on a roller, with a portion of the panel extended;

FIGS. 2a and 2e shows schematically a cross-sectional view representing a possible arrangement for the first configuration formed by the supporting member(s);

FIGS. 2b to 2d and 2f show schematically a plurality of cross-sectional views representing possible arrangements for the second configuration formed by the supporting member(s);

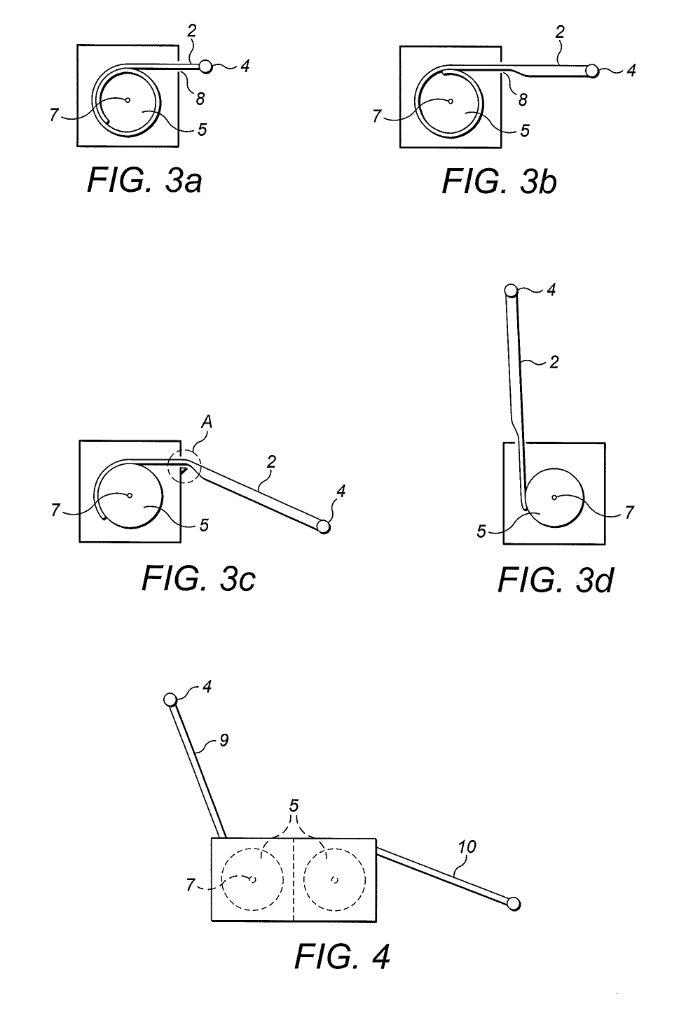

FIGS. 3a to 3d are schematic cross-sectional views illustrating the use of a flexible panel mounted on a roller, where the supporting members are in a first configuration within a housing and a second configuration outside of the housing;

FIG. 4 shows schematically a cross-sectional view of a support system, where two flexible panels are used and there is more than one roller;

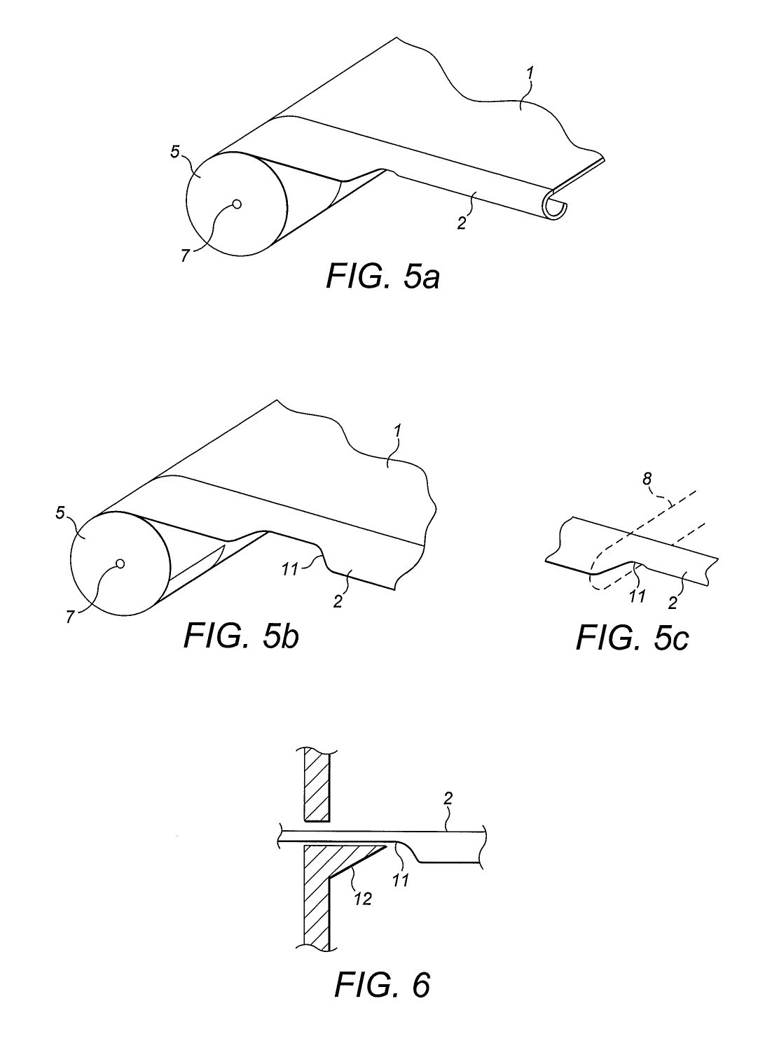

FIGS. 5a to 5c are schematic isometric views of the flexible panel illustrating the presence of a cut-away portion in a supporting member;

FIG. 6 shows schematically a cross-sectional view of a wedge shaped portion in contact with the supporting member of the flexible panel, as identified by the dotted lines A in FIG. 3c;

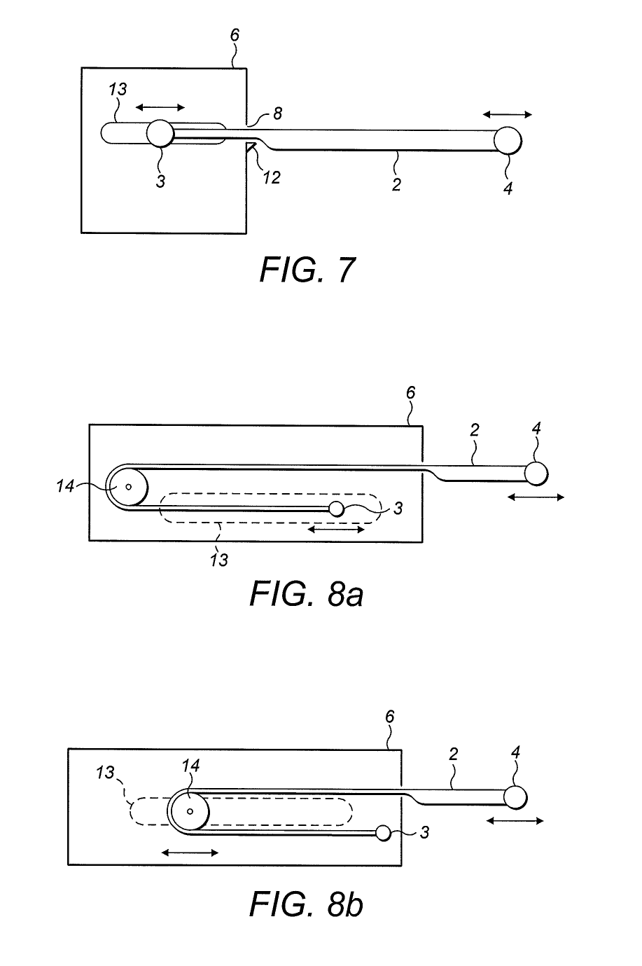

FIG. 7 shows schematically a cross-sectional view of a housing, where the flexible panel is mounted on a sliding mechanism and a wedge-shaped portion contacts the supporting members as they enter the housing;

FIG. 8a shows schematically a cross-sectional view of an example of a sliding arrangement; where one end of the flexible panel is free to move within a slot or indentation present in the housing.

FIG. 8b shows schematically a cross-sectional view of a further example of a sliding arrangement; where one end of the flexible panel is fixed to the wall of the housing.

FIGS. 1 and 2a to 2f illustrate generic features of examples of this invention. In FIG. 1, the flexible panel 1 is shown with two adaptable supporting members 2a and 2b positioned parallel (or substantially parallel) to each other. Supports 3 and 4 may be rigid or semi-rigid, for example semi-rigid poles, and each support can be positioned at either end of the panel 1. For ease of reference these supports are referred to hereafter as rigid supports. Supporting members 2a and 2b are formed from a memory material and can adopt either a flexible, rigid or semi-rigid configuration. In FIG. 1, both supporting members 2a and 2b are shown attached to the panel 1 and to the rigid supports (3 and 4) positioned perpendicular (or substantially perpendicular) to 2a and 2b, but opposite each other, thereby forming a frame around a flexible panel 1, which may be in the form of a square/rectangle. The rigid supports 3 and 4 can be designed to be rigid enough to provide support and tension across one dimension of the panel 1 substantially perpendicular to supporting members 2a and 2b to keep the panel flat, or substantially flat, when members 2a and 2b are in a rigid configuration. At least two of members 2a, 2b, 3 and 4 have at least one edge attached to one side of the flexible display panel 1; preferably at least 2a and 2b; more preferably all four members have at least one edge attached to one side of the display panel. Rigid support 3 may be in the form of a roller 5.

The adaptable supporting member(s) 2 may adopt both a flexible and rigid configuration by changing their form between at least two configurations. The first configuration may have a flat or substantially flat cross-section, as illustrated by FIGS. 2a and 2e, for example. Examples of alternative means of achieving the second configuration are illustrated by FIGS. 2b-2d and 2f. For example, the second configuration may have a substantially curved cross-section (see FIG. 2b) or a U-shaped cross-section (see FIG. 2c) or a rolled over circular cross-section (see FIG. 2d) if formed from FIG. 2a or a circular (see FIG. 2f) or substantially circular, oval, elliptical, semi-circular or substantially semi-circular cross-section if formed from FIG. 2e. A particular advantage of a closed loop, equivalent to FIGS. 2e and 2f, is that a single supporting member (or a series of parallel supporting members) may be used more easily and economically (or in greater numbers) across the breadth of, or part of the breadth of, the back surface of the flat panel 1 than an open loop, equivalent to FIGS. 2a to 2d, thereby reducing the total area of the flat panel 1.

FIGS. 3a to 8b describe a number of exemplary arrangements according to this invention, using two adaptable supporting members 2a and 2b.

The use of members 2a and 2b allows for a flexible panel 1 to be rolled up in a space saving manner. In a first example, as illustrated by FIGS. 3a to 3d, support 3 is a roller 5 onto which one end of both members 2a and 2b are fixed and one edge of the flexible panel 1 may also be fixed. One edge of members 2a and 2b may each be fixed to one edge of the panel. Alternatively, the members 2a and 2b may be fixed to the back or front of the flat panel 1, near its edge.

The purpose of the roller 5 is to provide a support for the panel 1 both when rolled onto the roller and when unrolled. The roller may be made of any suitably rigid metal, plastic or equivalent material. Surrounding the roller may additionally be a support system or housing 6 in which the roller 5 may be attached or mounted to allow it to freely rotate around an axle 7. The housing has an opening 8 to allow the panel to be extended through. The opening 8 is wider than the depth of the panel. The roller 5 may also have tapered ends (not illustrated) where the first configuration of supporting members 2a and 2b is slightly arced or curved. Providing the roller with tapered ends allows for compact storage by compensating for the additional volume of the supporting members 2a and 2b, where they are not flat in the first configuration.

Rigid support 4 may be attached to the opposite ends of members 2a and 2b to that of rigid support 3 or roller 5. Support 4 may be also attached to one edge of the panel 1. Alternatively, support 4 may be attached to the front or back of the flat panel or form part of it. Support 4 may be also another roller, similar to roller 5, supported by its own housing 6. Together with support 3, support 4 ensures that the flexible panel is kept taut. Equally, no support 4 may be used, if the application does not require it.

The roller 5 and housing 6 may also contain a spring mechanism, known to those skilled in the art, to assist in the rolling up of the panel 1 during retraction. It may also contain a locking mechanism preventing automatic retraction due to the spring load. The locking mechanism may be arranged such that it allows the retraction of the flexible panel 1 when the panel has been over-extended. This can either be achieved as described in the third example below, or by using a known system of preventing retraction, such as a ratchet mechanism, unless the panel 1 is pulled in a certain direction or with a particular force causing the mechanism to unlock the roller 5 thereby allowing it to turn and retract the panel by rolling up the panel. Alternatively, an electric motor, or equivalent, may be used to assist in retraction. The housing 6 may be made of metal, plastic or equivalent material. The housing may be configured in the form of a box, for example.

The roller 5 and/or housing 6 may also contain a heating element or an electrical charge/pulse generator to assist in or cause the transition of supporting members 2 from a first to a second configuration, or vice versa. The method used will depend on the memory material used.

More than one roller may be used to provide additional panels (see FIG. 4). In this second example, two rollers 5 may be used; one supporting a visual display panel 9 and the other a touchpad 10 in the form of a keyboard.

FIG. 5a illustrates the extension of the flexible panel 1 from a roller 5, according to any of the preceding examples. Whilst the flexible panel is extended in a first direction, the supporting member 2 makes the transition from a first configuration to a second configuration. The bend in supporting member 2 occurs in a second direction, substantially perpendicular to the first direction. To assist with the transition between the first and second configurations of supporting members 2, the ends of 2a and 2b may be attached to support 4 in their second configuration. This may be achieved through the use of slots in support 4, for example, or any alternative fixing means.

In a third example of this invention, supporting members 2a and 2b may have a slit, notch or cut-away portion 11 (see FIG. 5b, for example), positioned at a distance along each supporting member 2 such that it will be exposed outside the housing 6 when the flexible panel has been extended from the opening 8 as shown in FIG. 5c. In place of the cut-away portion 11, the same effect can be achieved by the use of a slit, a cut, a notch, an indentation or equivalent. The cut-away portion 11 may be any shape or size that does not impede the section of the supporting member 2 exposed outside the opening 8 of the housing 6 adopting a second configuration across its exposed length but which still allows enough material for the member 2 to be attached to and support the edge of the flexible panel.

This third example may also have an opening 8 which is narrower than the depth of the supporting member 2 in its second configuration. The advantage of having a narrow opening 8 is that it may be used to assist in the unfurling of member 2 from the second configuration to the first configuration during retraction (see FIG. 5c).

However, the narrow opening could prevent supporting member 2 from adopting the second configuration across its full length outside the housing 6. The use of a cut-away portion 11 allows this second configuration to be fully adopted along the full length of supporting member 2. A further advantage of the cut-away portion 11 is that retraction can be prevented by this mechanism. This allows the cut-away portion 11 to act as a lock to prevent retraction, if desired, for example, if the roller 5 is spring assisted. It may also act as a support, for example, keeping a display panel upright or a touchpad at a particular angle, depending on the shape of the cut-away portion 11.

The cut-away portion prevents the retraction of the flexible panel due to supporting member 2 being in the second configuration, which renders it too thick to fit through the opening 8. This may, however, be overcome by using an unlocking mechanism 12. FIG. 6, illustrates an example of an unlocking mechanism 12, according to a third example of the invention. The unlocking mechanism 12 may be attached to, or form part of, the housing 6. The unlocking mechanism 12 may be any shape that assists in the unfurling of member 2. The unlocking mechanism 12 may be formed from a wedge or pointer, or any alternative mechanism configured to unfurl the supporting member 2 from the second configuration to the first configuration. A wedge may be used for each supporting member 2, the wedge being positioned either above, below or to the side of opening 8, as appropriate depending on the configuration of the second configuration, but adjacent to supporting member 2. For example, the wedge might be triangular in shape or a shape consisting of a point at its end but conforming to the unfurling shape of supporting member 2 across its length, at any point in time, during retraction. The unlocking mechanism 12 should be positioned to interact within the enclosed open space of the second configuration cross-section of supporting member 2 during retraction. When force is then applied in the direction of the roller 5 to retract the panel the unlocking mechanism 12 forces the supporting member 2 to unfurl as the member retracts into the housing 6. The unlocking mechanism 12 ensures, through its shape, that the cross-section of supporting member 2 approaches that of the first configuration shortly before reaching the opening 8.

This unlocking mechanism 12 thereby enables supporting member 2 to both fully adopt the rigid second configuration, following exposure of the cut-away portion 11 from opening 8, whilst still allowing the second configuration to be returned to the flexible first configuration, as the flexible panel 1 is retracted. The combination of these features enables the conversion of the adaptable supporting member 2 between the first and second configuration, i.e. between flexible and rigid configurations, at suitable positions. The flexible panel is supported when extended, whilst full retraction (or rolling up) of the flexible panel is also ensured.

The unlocking mechanism 12 detailed above describes a device capable of applying a force to the memory material to cause or induce a change from one configuration to another. It is also possible to convert or to assist the conversion of the memory material from one configuration to another using alternative, or additional, methods. For example, heat or an electrical pulse can be applied, either when applying a force on the flexible panel 1 in the direction of retraction through the opening 8 or by activating an electrical switch or its equivalent. The method used will depend on the memory material selected and/or the application.

A further example of this invention uses the unlocking mechanism, described above, to allow a flexible panel to adopt either a flexible or rigid configuration without the use of a roller.

In this fourth example, illustrated in FIG. 7, the supports 3 and 4 are rigid (or semi-rigid) structures made of plastic, metal or an equivalent material onto which are attached the ends of members 2a and 2b and optionally one edge of the flexible panel, in a similar manner to that described in the first example. Alternatively, any or all of members 2a and 2b and supports 3 and 4 may also form part of the flexible panel 1. At least one of the supports 3 and 4 is also surrounded by a housing 6 containing an opening 8 and unlocking mechanism 12 for each member 2a and 2b as described in the third example. In this example the housing does not contain a roller as in the first and second examples. To assist in the effectiveness of the unlocking mechanism 12 in unfurling supporting members 2 a sliding mechanism as shown in FIG. 7 may be used in the housing 6. The sliding mechanism allows, for example, support 3 to slide either backwards or forwards within the housing 6 in a constrained manner.

The sliding mechanism may simply consist of linear indentations 13 at opposite sides of the housing 6 into which the two opposite ends of support 3 may fit and slide freely in one dimension allowing movement both forwards and backwards. The sliding mechanism may also contain a spring mechanism favouring a backwards/retracted position to assist in unfurling members 2a and 2b. There may be a series of linear indentations (for example, in a “zig-zag” pattern) within the housing and the flexible panel 1 may be able to slide into a folded or bent position in order to maximise the use of space within the housing 6.

In this fourth example, supporting members 2a and 2b have a cut-away portion 11 at one end (or both ends if both supports 3 and 4 have a housing 6 with unlocking mechanism 12), in a similar manner as in the third example, which when the support 3 is slid forward is exposed outside the housing but when slid backwards is located in the housing. Upon sliding the panel 1 back into the housing, using force, the unlocking mechanism 12 initially causes a part of members 2a and 2b to unfurl. Using the appropriate material, depending on the size and purpose of the panel, the material may unfurl across its whole length, as a consequence of the force of the initial unfurling, to adopt a first configuration from a second configuration. This first configuration then allows the panel to become flexible. Equally, when the cut-away portions 11 of members 2a and 2b are exposed, by force being applied to, for example support 4, to pull panel 1 to a forward position, supporting members 2a and 2b adopt a second configuration returning the panel to a rigid configuration.

This mechanism therefore allows a panel to adopt either a rigid or flexible configuration simply by using a pulling or pushing motion, respectively.

To further assist in the unfurling of support members 2a and 2b both supports 3 and 4 may have a housing 6 using both the sliding mechanism and the unlocking mechanism described in this third example.

Equally, for certain situations where the material of members 2a and 2b allows unfurling across the lengths of members 2a and 2b without the assistance of unlocking mechanism 12 to force a change of configuration, it is possible to use no unlocking mechanism 12. In these situations members 2a and 2b do not need to contain a cut-away portion 11. In this example, the ends of members 2a and 2b should preferably be attached to supports 3 and/or 4, contained in a housing 6, in their first configuration.

Example 4 (above) describes a device capable of applying force to the memory material to cause or induce a change from one configuration to another. It is also possible to convert or to assist the conversion of the memory material from one configuration to another using alternative or additional methods including, for example, the application of heat or an electrical pulse.

A fifth example is illustrated in FIG. 8a. In this example, the housing 6 may contain both a sliding mechanism described in the fourth example and a roller 14. The roller can be fixed to opposite ends of the housing 6 on an axle allowing it to rotate and can be positioned parallel to support 3, whilst the ends of support 3 are fitted into an indentation 13. As an alternative, the roller can be fixed to prevent rotation, forming a guiding surface. A fixed guide or support can also be used as a substitute for a roller. The roller 14 or fixed guide's position in the housing 6 depends on the desired arrangement for the flexible panel, but should preferably be placed further back in the housing 6 than the effective use of indentation 13. Supporting members 2a and 2b, and the flexible panel 1, may then move over and around the roller 14 when pushed or pulled while support 3 may slide freely along the indentation 13 as shown in FIG. 8a. Support 3 may also be attached to a spring to aid in retraction of the panel.

This example allows the use of a roller to assist in forcing supporting members 2a and 2b into adopting a first configuration and gives the advantage of space saving in the support system or housing, in one dimension, over the first or fourth example.

In a sixth example both the sliding mechanism and roller system described in the fifth example are used. In this example, however, support 3 is fixed to the housing, or is a part of housing 6 to which members 2a and 2b are attached (preferably in their first configuration), and the axle of roller 14 is fitted to move freely in the indentation 13 as shown in FIG. 8b. The fixed position of support 3 depends on the system set up but should preferably be further forward in the supporting system or housing 6 than the effective use of indentation 13. The roller 14 may be attached to a spring to assist in retraction of the panel.

This example has a further advantage over the fifth example, as it allows a greater proportion of the panel 1 to be exposed outside of the supporting system or housing 6.

For both the fifth and sixth examples unlocking mechanisms 12 may or may not be used on the housing 6 and supporting members 2a and 2b may or may not need to contain a cut-away portion 11, as in the first and fourth examples. For example, the unlocking mechanism 12 may not need to be used if the application of heat or an electric pulse is used to assist or cause the transition of members 2a and 2b from a first to a second configuration, or vice versa. Equally, the fifth and sixth examples may be used without the combination of supporting members 2a, 2b and support 4.

The skilled person will realise that some of the above examples may be used in combination. For example, the fourth example may also be used in combination with the first, second or third example. Support 3 may use the mechanism of either the first, second or third example and support 4 may use the simpler mechanism of the fourth example.

The skilled person will also realise that the housing 6 may enclose other systems, such as electronic or mechanical elements, associated with the panel and that any of the members, 2a, 2b and any of the supports 3, 4 may be used to connect the panel to such systems where required.

The above examples and embodiments have been described by way of example only, and the described examples are to be considered in all respects only as illustrative and not restrictive. It will be appreciated that variations of the described examples may be made without departing from the scope of the invention.

1. A system for supporting a flexible panel comprising:
at least one rigid or semi-rigid support; and
at least one supporting member formed from a memory material, the memory material being flexible in a first configuration and rigid in a second configuration and having a substantially flat cross-section in the first configuration and a substantially curved, bent or circular cross-section in the second configuration.

2. (canceled)

3. A system for supporting a flexible panel according to claim 1, wherein the at least one supporting member is positioned substantially perpendicular to the at least one rigid support.

4. A system for supporting a flexible panel according to claim 1, wherein the at least one supporting member is positioned at an angle of between 30-60° to the at least one rigid support.

5. A system for supporting a flexible panel according to claim 1, comprising at least two supporting members formed from a memory material.

6. A system for supporting a flexible panel according to claim 1, where at least one of the supporting member or the rigid support is attached at or near to the edge of the flexible panel.

7. A system for supporting a flexible panel according to claim 1, wherein the memory material is arranged to bend, curve or expand independently of the flexible panel.

8. A system for supporting a flexible panel according to claim 1, further comprising a mechanism arranged to exert a force upon the memory material in order to change or assist in the change of the configuration of the memory material.

9. A system for supporting a flexible panel according to claim 1, further comprising a mechanism for applying heat to the memory material in order to change or assist in the change of the configuration of the memory material.

10. A system for supporting a flexible panel according to claim 1, further comprising a mechanism for applying an electrical pulse or current to the memory material in order to change or assist in the change of the configuration of the memory material.

11. A system for supporting a flexible panel according to claim 1, comprising at least two rigid or semi-rigid supports.

12. A system for supporting a flexible panel according to claim 1, wherein the memory material includes at least one cut-away portion.

13. A system for supporting a flexible panel according to claim 1, wherein the panel is arranged to pass over guiding means.

14. A system for supporting a flexible panel according to claim 13, wherein the guiding means comprises a roller.

15. A system for supporting a flexible panel according to claim 1, wherein the panel is secured within a housing.

16. A system for supporting a flexible panel according to claim 15, where the housing further comprises an opening through which the panel can pass.

17. A system for supporting a flexible panel according to claim 15, wherein the housing comprises at least one internal indentation or slot, and where a first end of the panel is arranged to move within the confines of the internal indentation or slot.

18. A system for supporting a flexible panel according to claim 17, wherein a central portion of the panel is arranged to pass over guiding means.

19. A system for supporting a flexible panel according to claim 15, wherein the housing comprises at least one internal indentation or slot, and wherein a first end of the panel or its supporting means is mounted to a fixed point within the housing and a central portion of the panel is arranged to pass over guiding means, and the guiding means is arranged to move within the confines of the internal indentation or slot.

20. A system for supporting a flexible panel according to claim 15, wherein part of the housing comprises a wedge adapted to cause or assist in a transition of the configuration of the memory material.

21. A system for supporting a flexible panel according to claim 14, wherein a first end of the panel or its supporting member is fixed to a roller.
